(19) United States
(12) Patent Application Publication
(10) Pub. No.: US 2015/0089750 A1
(43) Pub. Date: Apr. 2, 2015

(54) CONFIGURABLE FOAM CUSHIONING STRUCTURE FOR PROVIDING VARIABLE SUPPORT PROFILES IN MATTRESS COMPONENTS, AND RELATED MATTRESS ASSEMBLIES AND METHODS

(71) Applicant: Nomaco Inc., Zebulon, NC (US)

(72) Inventor: Jozsef Kertesz, Raleigh, NC (US)

(21) Appl. No.: 14/499,588

(22) Filed: Sep. 29, 2014

Related U.S. Application Data
(60) Provisional application No. 61/883,645, filed on Sep. 27, 2013.

(51) Int. Cl. A47C 27/14; B29C 47/00

(52) U.S. Cl. CPC A47C 27/14; A47C 27/144; B29C 47/0066; B29C 2793/0054; B29K 2105/04
USPC 5/740; 264/46.1; 156/244.18

(57) ABSTRACT

A configurable foam cushioning structure for providing variable support profiles in mattress components is disclosed, and related mattress assemblies and methods. In one embodiment, a plurality of extruded support members are provided each having a top surface and a bottom surface that extend in an extrusion direction and two end surfaces that extend in a direction transverse to the extrusion direction. The extruded support members are connected to each other in a linear array defining a substantially planar lower surface, with one end surface of each of the plurality of extruded support members is substantially coplanar with the lower surface. In this manner, the structure can be easily extruded as one long, continuous piece, and reconfigured into a structure having a relatively short dimension in the extrusion direction and a relatively long dimension in the transverse direction.

### PRIORITY APPLICATIONS

The present application claims priority to U.S. Provisional Patent Application Ser. No. 61/883,645, filed on Sep. 27, 2013, entitled “CONFIGURABLE FOAM CUSHIONING STRUCTURE FOR PROVIDING VARIABLE SUPPORT PROFILES IN MATTRESS COMPONENTS, AND RELATED MATTRESS ASSEMBLIES AND METHODS,” which is hereby incorporated herein by reference in its entirety.

### FIELD OF DISCLOSURE

The field of the disclosure relates generally to mattress assemblies, mattresses, and related methods providing support, which may be employed in bedding and seating applications.

### BACKGROUND

Innerspring assemblies are a type of mattress core utilized for mattresses or seating structures and may be composed of spring coils attached together in a matrix or array. An example of a mattress 10 containing an innerspring assembly 12 (“innerspring 12”) is illustrated in FIG. 1. The innerspring 12 is comprised of conventional coils 14 arranged in an interconnected matrix to form a flexible core and support surfaces of the mattress 10. Adjacent coils 14 are secured to one another by lower interconnection helical wires 16 and upper interconnection helical wires 18. At a perimeter 20 of the innerspring 12, coils 14 are also connected to one another by upper and lower border wires 22, 24. Upper and lower border wires 22, 24 are attached to upper and lower end turns of the coils 14 to create a frame 26 for the innerspring 12. The upper and lower border wires 22, 24 may provide firmness for edge support on the perimeter 20 of the innerspring 12 where an individual user may disproportionally place weight on the innerspring 12, such as during mounting onto and dismounting from the mattress 10.

With continuing reference to FIG. 1, the innerspring 12 may be disposed on top of a base 28 to provide base support. The base 28 may be comprised of foamed polymer to provide cushioned support for the innerspring 12. The foamed polymer may be extruded to form the base 28. In this example, the extruded base 28 extends in an extrusion direction 30 and in a direction 32 transverse to the extrusion direction 30. To provide further perimeter structure and edge-support for the innerspring 12 in FIG. 1, edge-support members 34 (also referred to as “side-support members 34”) may be disposed around the coils 14 proximate to an edge 30 of the innerspring 12, between the base 28 and the upper and the lower border wires 22, 24. The foam side-support members 34 may be extruded from polymer foam, as an example. The foam side-support members 34 are secured to the base 28 to provide an encasement 36 for the innerspring 12. The foam side-support members 34 being disposed orthogonally to the base 28 to provide the encasement 36 thereby provides an interior area 38 inside the encasement 36 to receive and support the innerspring 12. The foam side-support members 34 can be secured to the foam base 28 through use of an adhesive or thermal bonding, as non-limiting examples. One or more padding material layer 40 may be disposed on top of the innerspring 12. Upholstery 42 (“ticking”) can then be placed around the padding material layer(s) 40, innerspring 12, the foam side-support member 34, and base 28 to form the mattress 10 in its fully assembled state. The mattress structure in FIG. 1 may also be provided for other types of innersprings, including pocketed coils.

Certain components of the mattress 10 may be manufactured separately and shipped to secondary manufacturers or assemblers that assemble the entire mattress 10. It may also be desired to ship components of the mattress 10 to an end user in unassembled form, for the end user to assemble or have the components assembled into the mattress 10. In either case, it is desirable to find ways to compact the mattress 10 and/or its components to reduce their volume during shipping, thus reducing shipping costs. It may be desired to provide the encasement 36 in assembled form to avoid a secondary manufacturer or assembler, or an end user, from having to engage in the complexity and skill of applying adhesives or thermal bonding to secure the foam side-support members 34 to the base 28. However, shipping the encasement 36 in assembled form may still be expensive. The foam side-support members 34 of the encasement 36, being disposed around all edges of the base 28 and secured to each other, do not allow the encasement 36 to be folded to reduce the volume of the interior space 38 of the encasement 36 during shipment.

### SUMMARY OF THE DETAILED DESCRIPTION

Embodiments of the present disclosure include a configurable foam cushioning structure for providing variable support profiles in mattress components, and related mattress assemblies and methods. In one embodiment, an extruded foam cushioning structure for a mattress is provided, including a plurality of extruded support members each having a top surface and a bottom surface that extend in an extrusion direction and two end surfaces that extend in a direction transverse to the extrusion direction. The extruded support members are connected to each other in a linear array defining a substantially planar lower surface, with one end surface of each of the plurality of extruded support members that is substantially coplanar with the lower surface. In this manner, the structure can be easily extruded as one long, continuous piece, i.e., having a relatively long dimension in the extrusion direction and a relatively short dimension in the transverse direction, and reconfigured into a structure having a relatively short dimension in the extrusion direction and a relatively long dimension in the transverse direction.

According to an exemplary embodiment, an extruded foam cushioning structure for a mattress comprises a plurality of extruded support members each having a top surface and a bottom surface that extend in an extrusion direction and two end surfaces that extend in a direction transverse to the extrusion direction. The plurality of extruded support members are connected to each other in a linear array defining a substantially planar lower surface, wherein one end surface of each of the plurality of extruded support members is substantially coplanar with the lower surface.

According to another exemplary embodiment, a method of forming a foam cushioning structure is disclosed. The method comprises providing an extruded foam structure having a top surface and a bottom surface that extend in an extrusion direction and two end surfaces that extend in a direction transverse to the extrusion direction. The method further comprises cutting the extruded foam structure in the transverse direction at a plurality of locations along the extrusion direction of the extruded foam structure to form a plurality of extruded support members each having a top surface and a bottom surface that extend in the extrusion direction and two end surfaces that extend in the transverse direction. The method further comprises arranging the plurality of extruded support members such that the extruded support members are connected to each other in a linear array such one of the end surfaces of each of the plurality of extruded support members are coplanar with each other.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF FIGURES

FIG. 1 is a perspective partial cutaway view of a mattress in the prior art including an innerspring disposed in an interior area of an encasement formed from side-support members secured around the edge of a base;

FIGS. 2A through 2E illustrate a flat cushioning structure having cuts and living hinges for rotating adjacent support members 180° with respect to each other in order to reconfigure the dimensions of the structure in the extrusion and transverse directions, according to an exemplary embodiment;

FIG. 3 illustrates the cushioning structure of FIGS. 2A through 2E folded into a stacked configuration, in which the width of the cushioning structure is halved and the height of the cushioning structure is doubled;

FIG. 4 illustrates the cushioning structure of FIGS. 2A through 2E folded into an alternative stacked configuration, in which the width of the cushioning structure is quartered and the height of the cushioning structure is quadrupled;

FIG. 5 illustrates a cushioning structure according to another alternative embodiment having non-uniform distances between cuts and hinges of the support members, such that the resultant folded configuration has a non-uniform shape and support profile;

FIGS. 6A through 6C illustrate a cushioning structure for a chair back support according to an alternative embodiment having non-uniform distances between cuts and hinges of the support members, such that the resultant folded configuration has a non-uniform shape and support profile;

FIGS. 7A through 7C illustrate a cushioning structure having a customized shape and support profile in which non-uniform distances are selected between cuts and hinges of the support members, such that the resultant folded configuration has a non-uniform shape and support profile;

FIGS. 8A and 8B illustrate a plurality of cushioning structures with custom configurations and assembled together into a mattress support assembly having a standard shape profile and a customized support profile;

FIGS. 9A through 9D illustrate a cushioning structure having two different materials connected together prior to cutting and folding the cushioning structure, according to an alternative embodiment;

FIGS. 10A through 10D illustrate a cushioning structure having a plurality of elements of a second material connected to the base support members prior to cutting and folding the cushioning structure, according to an alternative embodiment;

FIGS. 11A and 11B illustrate a comparison of stress profiles at 10% compression for an exemplary extruded support member in the extrusion direction and the transverse direction, according to an exemplary embodiment; and

FIGS. 12A and 12B illustrate a comparison of stress profiles at 50% compression for an exemplary extruded support member in the extrusion direction and the transverse direction similar to the stress profiles of FIGS. 11A and 11B, according to an exemplary embodiment.

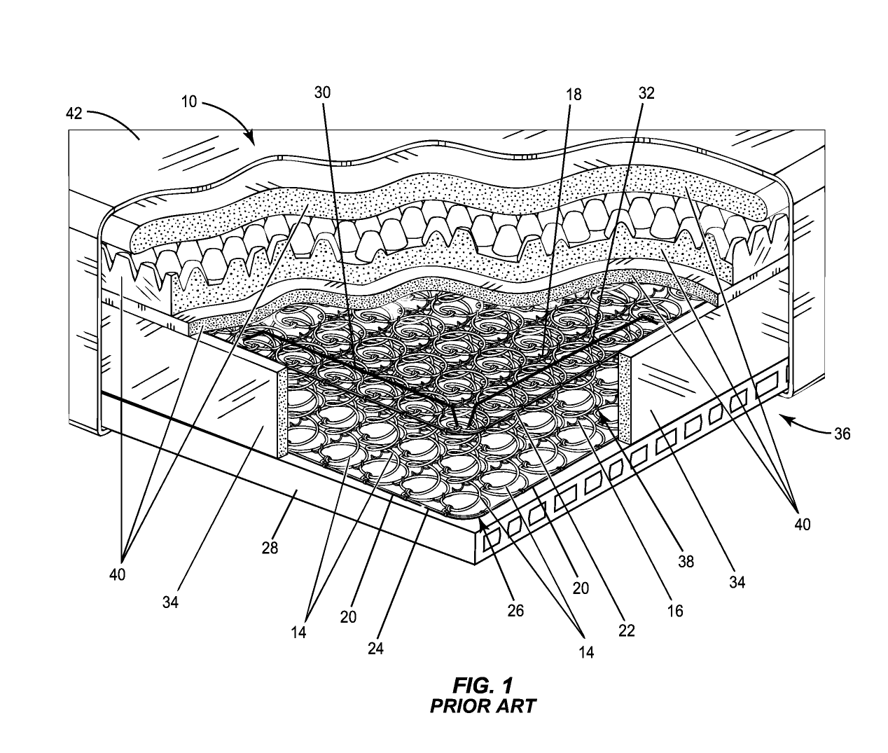

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Extruded foam members, such as foam members described herein, have significantly different strength in compression properties in the extrusion direction as opposed to in transverse directions. For example, an extruded foam member is significantly stiffer and less susceptible to compression in the extrusion direction. However, exploiting these differences in compressive strength currently involves costly and time consuming manufacturing steps.

Embodiments of the present disclosure include a configurable foam cushioning structure for providing variable support profiles in mattress components, and related mattress assemblies and methods. In one embodiment, an extruded foam cushioning structure for a mattress is provided, including a plurality of extruded support members each having a top surface and a bottom surface that extend in an extrusion direction and two end surfaces that extend in a direction transverse to the extrusion direction. The extruded support members are connected to each other in a linear array defining a substantially planar lower surface, with one end surface of each of the plurality of extruded support members is substantially coplanar with the lower surface. In this manner, the structure can be easily extruded as one long, continuous piece, i.e., having a relatively long dimension in the extrusion direction and a relatively short dimension in the transverse direction, and reconfigured into a structure having a relatively short dimension in the extrusion direction and a relatively long dimension in the transverse direction.

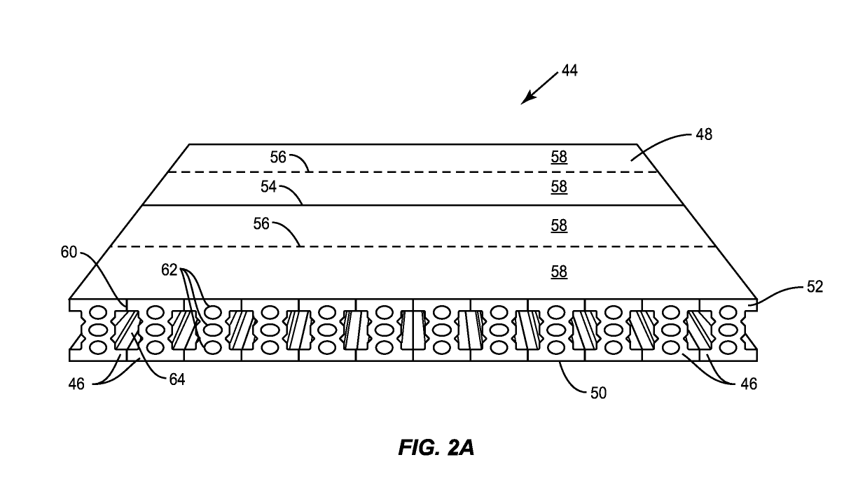

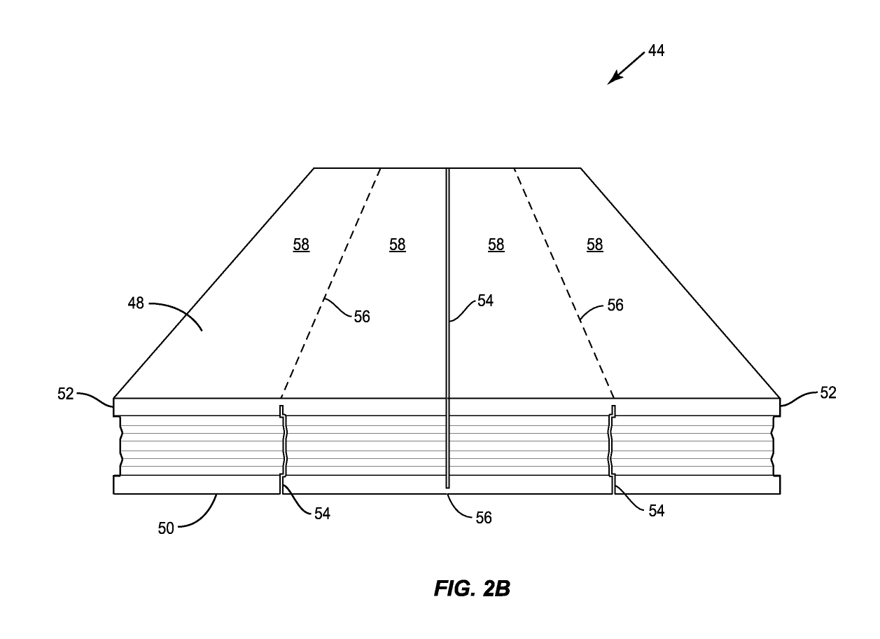

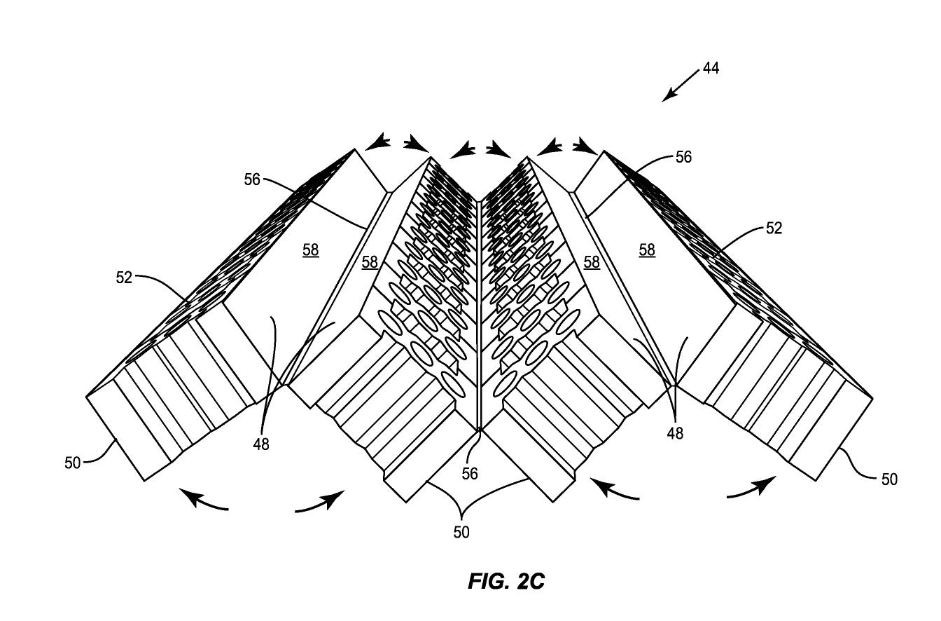

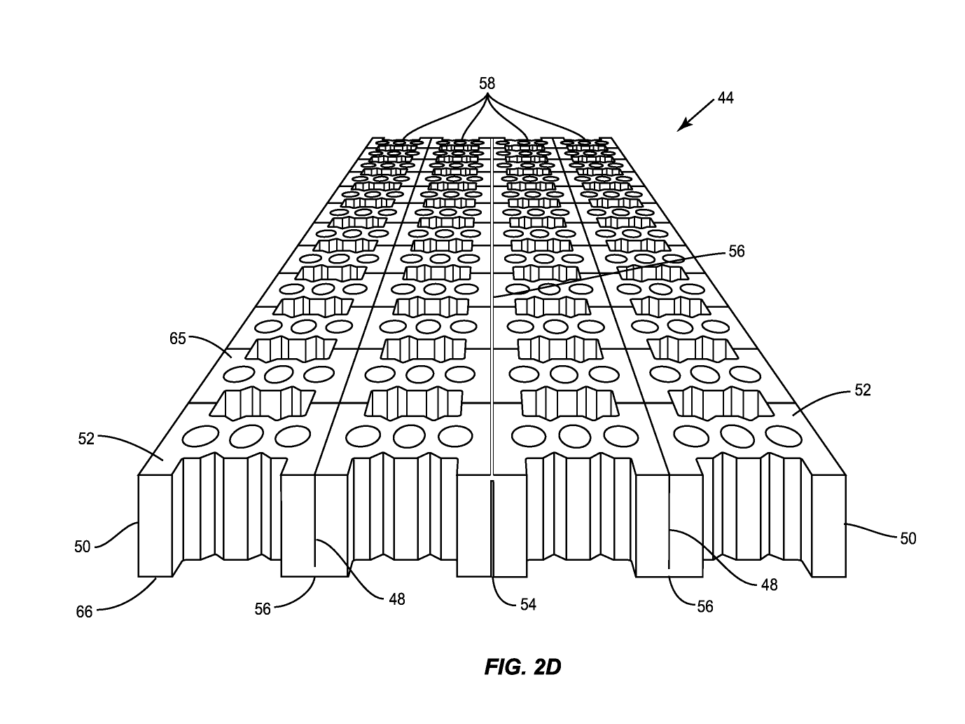

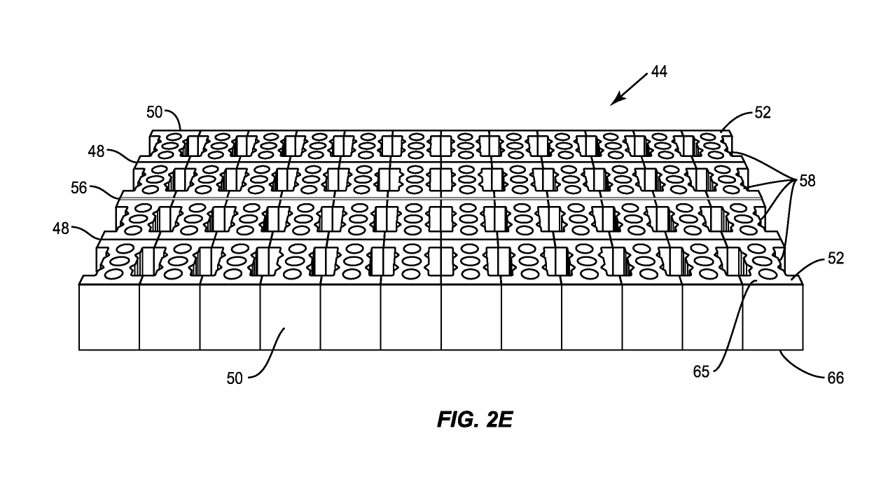

In this regard, FIGS. 2A through 2E illustrate a foam cushioning structure 44 that is able to be reconfigured to change the dimensions and orientation of the structure in the extrusion and transverse directions, according to an exemplary embodiment. The cushioning structure 44 includes a plurality of extruded support sub-members 46 connected in a linear array in a direction transverse to an extrusion direction. The extruded support sub-members 46 together define a top surface 48 and bottom surface 50 extending parallel to the extrusion direction, and the pair of end surfaces 52 extending transverse to the extrusion direction.

The cushioning structure 44 includes a plurality of cuts 54 extending transverse to the extrusion direction. In this embodiment, each alternating cut 54 defines a hinge 56 connecting a pair of extruded support members 58 also defined by the alternating cuts 54.

The alternating hinges 56 permit each extruded support member 58 to rotate one hundred eighty (180) degrees with respect to each adjacent extruded support member, such that one of the end surfaces 52 of each of the plurality of extruded support members 58 are all co-planar with each other. In this manner, the increased stiffness of the extruded support members 58 in the extrusion direction may be employed for vertical support within a foam cushioning structure 44. This permits additional versatility for using foam components within a cushioning structure 44 or other support structure.

As noted above, the plurality of extruded support sub-members 46 are arranged in a linear array in the transverse direction to form cushioning structures 44. Each extruded support sub-member 46 is connected to one or more adjacent extruded support sub-members 46 in the array, for example, by a weld 60 or other connection method, such as an adhesive. The extruded support sub-members 46 may comprise a uniform block of foam, or, as in this example, may define a predetermined foam profile. In this regard, the extruded support sub-members 46 of FIGS. 2A through 2E have an “I-beam” style profile, and also include a plurality of small channels 62 extending therethrough in the extrusion direction. When the individual extruded support sub-members 46 are connected to each other, for example via welds 60, the connected extruded support sub-members 46 also define a larger channel 64 therebetween. In this manner, a foam structure having sufficient support characteristics may be formed while conserving the amount of foam material used in the extrusion process.

Referring now to FIG. 2B, a side view of cushioning structure 44 is illustrated, showing the alternating cuts 54 and hinges 56 between the extruded support members 58. As shown in FIG. 2C, each extruded support member 58 can then be located 180° with respect to each adjacent extruded support member 58.

FIGS. 2D and 2E illustrate cushioning structure 44 in an end configuration with each extruded support member 58 arranged in a linear array such that one of the end surfaces 52 of each of the extruded support members 58 are all coplanar with each other. In this configuration, the end surfaces 52 cooperate to define an upper surface 65 and lower surface 66 for the cushioning structure.

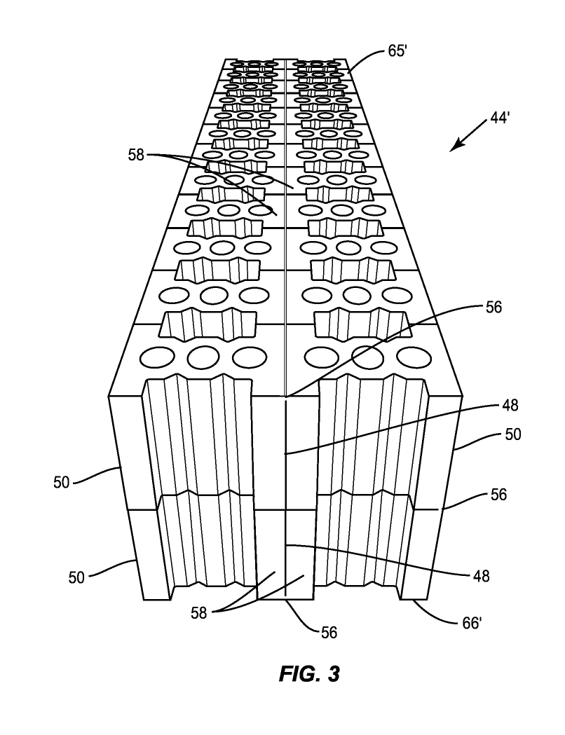

Hinges 56 may also permit different configurations for the cushioning structure 44. In this regard, FIG. 3 illustrates the cushioning structure of FIGS. 2A through 2E folded into a stacked configuration, in which the width of the cushioning structure is halved and the height of the cushioning structure is doubled, according to an alternative embodiment. In this embodiment, the extruded support members 58 are rotated 180° with respect to each other, after which half of the cushioning structure 44′ is rotating 180° back with respect to the other half. This configuration defines an upper surface 65′ and lower surface 66′ having a smaller overall area, while the top surfaces 48 and bottom surfaces 50 of the extruded support members define a taller overall cushioning structure 44′. In this manner, a cushioning structure having a smaller area but increased thickness may be achieved.

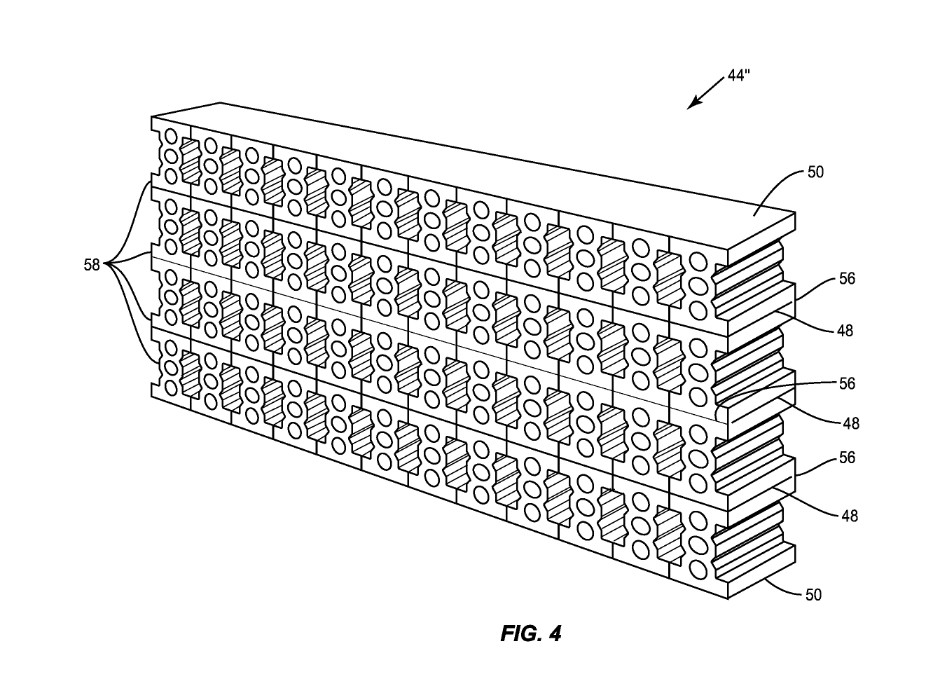

In this regard, FIG. 4 illustrates the cushioning structure 44 of FIGS. 2A through 2E folded into an alternative stacked configuration, in which the width of the cushioning structure is quartered and the height of the cushioning structure is quadrupled. In this embodiment, the plurality of layers of extruded support members 58 may be stacked vertically, for example to be used as a side support structure in a mattress or other cushioning location.

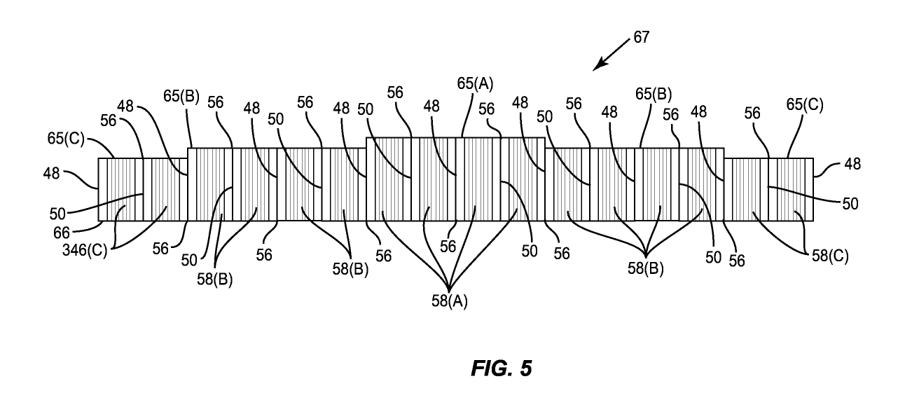

It should be understood that the dimensions of each individual extruded support member 58 need not be uniform. In this regard, FIG. 5 illustrates a cushioning structure according to another alternative embodiment having non-uniform distances between cuts 54 and hinges 56 of the support members, such that the resultant folded configuration has a non-uniform shape and support profile. In this alternative cushioning structure 67, the alternating cuts 54 are spaced at differing intervals, thereby defining extruded support members 58 having three (3) different lengths. In this manner, when the extruded support members 58 are rotated 180° with respect to each other, the resulting cushioning structure 67 has a variable height, with a corresponding varying amount of vertical stiffness. For example, extruded support member 58A, located in the midpoint of cushioning structure 67 in this example, provides additional rigidity due to increased height, while extruded support member 58B provides an intermediate level of rigidity, and extruded support member 58C provides a reduced level of rigidity.

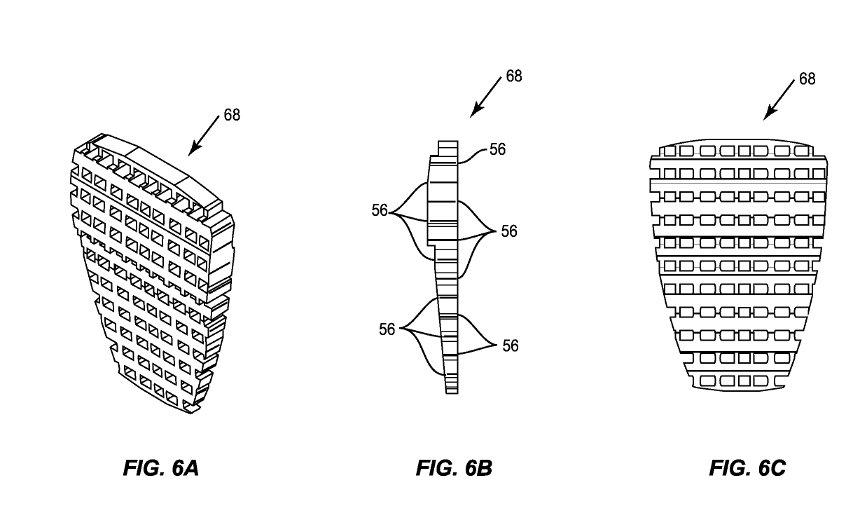

It should also be understood that cushioning structures disclosed herein need not define a rectilinear footprint. In this regard, an alternative cushioning structure 68 is illustrated in which the alternating cuts 54 and hinges 56 define a variable height cushioning structure 68, for use with a chair, for example. The variable height cushioning structure 68 also has a variable height and width, for example. In this regard, FIGS. 6A through 6C illustrate a cushioning structure for a chair back support according to an alternative embodiment having non-uniform distances between cuts 54 and hinges 56 of the support members, such that the resultant folded configuration has a non-uniform shape and support profile. As illustrated through FIGS. 6A through 6C, any of the above dimensions may be customized or altered as desired, in order to conform to desired cushioning requirements of a chair or other cushioning application.

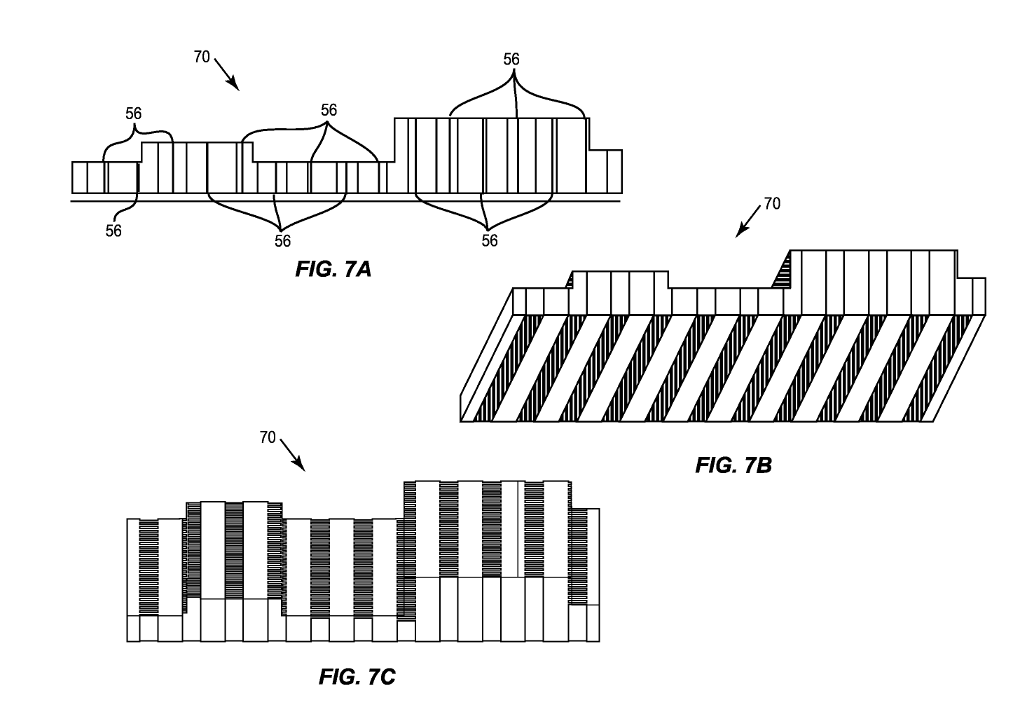

In this regard, FIGS. 7A through 7C illustrate a cushioning structure 70 having a customized shape and support profile in which non-uniform distances are selected between cuts 54 and hinges 56 of the support members 58, such that the resultant folded configuration has a non-uniform shape and support profile. As a result, the cushioning structure 70 may have portions of varying height, with corresponding varying rigidity. By disposing cushioning structures having different rigidities within the voids defined by the different sections of cushioning structures, a variable cushioning profile may be achieved.

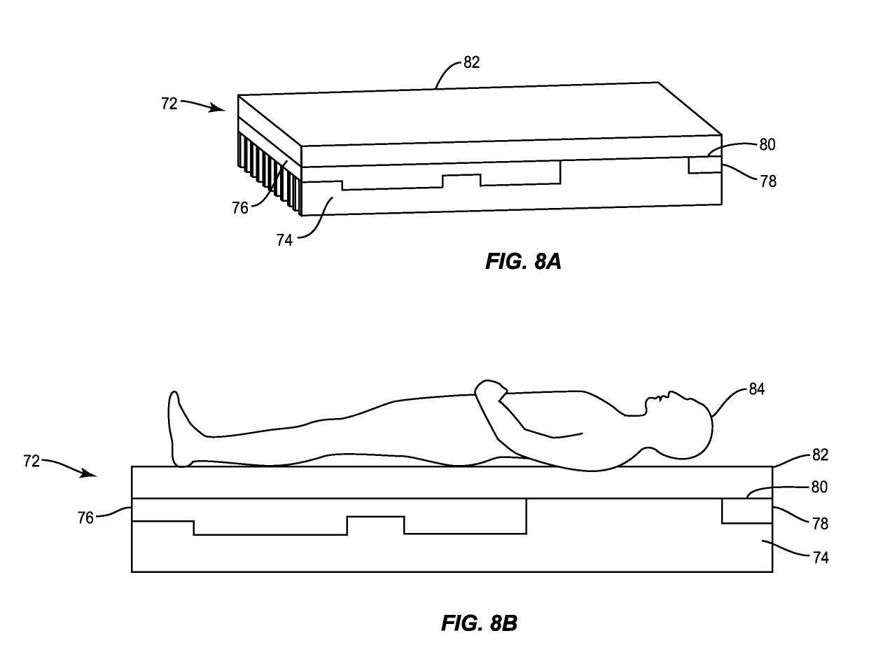

In this regard, FIGS. 8A and 8B illustrate a variable rigidity mattress structure 72 having a plurality of cushioning structures with custom configurations and assembled together into a mattress support assembly having a standard shape profile and a customized support profile. The mattress structure 72 includes a first cushioning structure 74 similar to the cushioning structure 70 of FIGS. 7A through 7C. Second and third cushioning structures 76, 78 are disposed on top of the recesses formed by first cushioning structure 74 to define a planar support surface 80. Finally, a uniform cushioning structure 82 is disposed on the planar support surface 80 to define a flat upper surface for the mattress structure 72. As shown in FIG. 8B, when a user 84 employs the mattress structure 72, different regions of the mattress structure 72 will have different rigidities, due to the variable height of first cushioning structure 74. In this manner, a customized cushioning profile may be achieved for mattress structure 72.

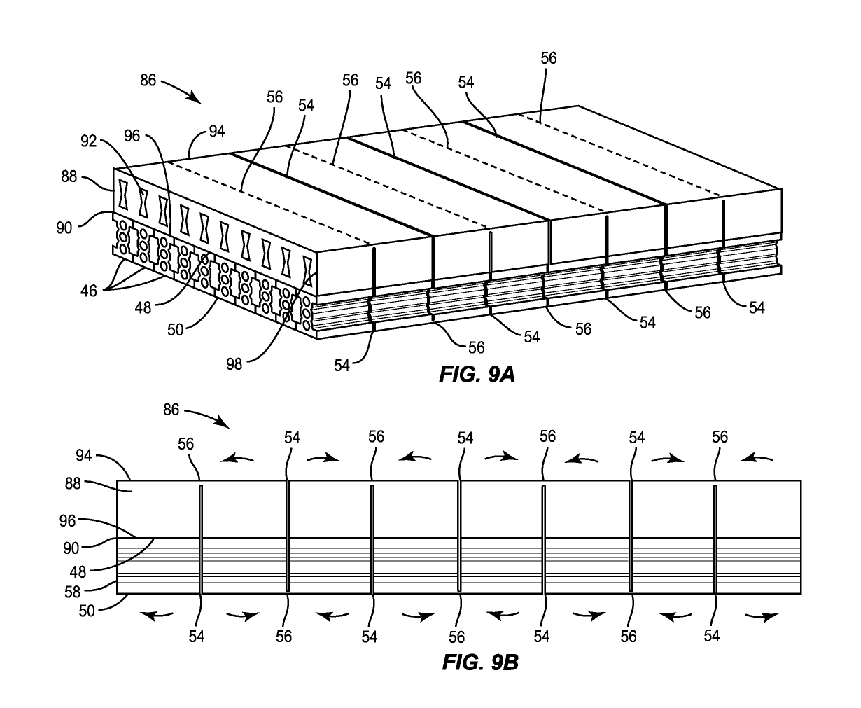

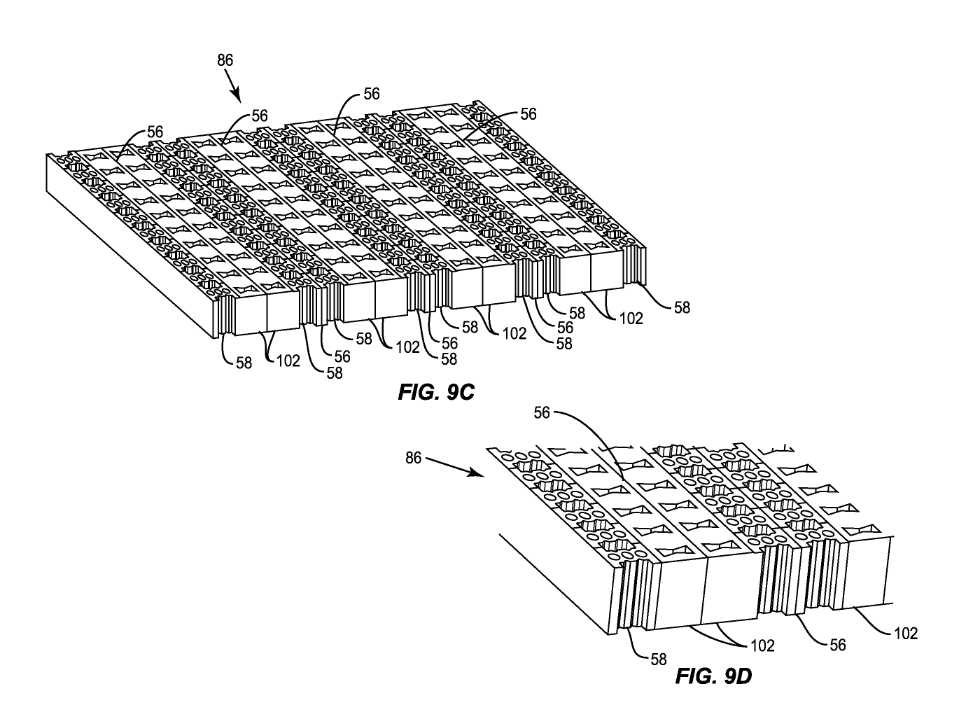

In some embodiments, different materials may be employed to create different cushioning profiles within a uniform cushioning structure. In this regard, FIGS. 9A through 9D illustrate a cushioning structure 86 having two different materials connected together prior to cutting and folding the cushioning structure 86, according to an alternative embodiment. In the embodiment of FIGS. 9A through 9D, the cushioning structure 86 includes a second cushioning assembly 88, such as an array of support member formed of a different material from the material used for extruded support sub-members 46 and/or having a different extrusion profile. As a result, the addition of second assembly 88 prior to cutting and reconfiguring the cushioning structure 86 would combine different mechanical properties in the same cushioning structure 86 while minimizing the extra process steps needed to achieve the modified cushioning structure 86. For example, in this embodiment, each of the extruded support sub-members 46 is formed from polyethylene, while the second assembly 88 is formed from polyurethane. Different materials may be joined at connection interface 90 by welding, adhesive, or other connection method. It should also be understood that, similar to the extruded support sub-members 46, the second assembly 88 may also include a predetermined foam profile, such as foam profile 92, or may be a uniform block of material, as desired.

The second assembly 88 includes a top surface 94, and a bottom surface 96 extending parallel to the extrusion direction. In this embodiment, the bottom surface 96 of the second assembly 88 is bonded to the top surface 48 of the extruded support sub-members 46 at connection interface 90, by welding or adhesive for example. In this example, end surface 98 of second assembly 88 is also substantially coplanar with end surface 52 of the extruded support sub-members 46. When the cushioning structure 86 is rearranged by rotating the individual sections about hinges 56, the resulting cushioning structure 86 has alternating sections of first and second materials, thereby providing a hybrid cushioning profile for the cushioning assembly 86.

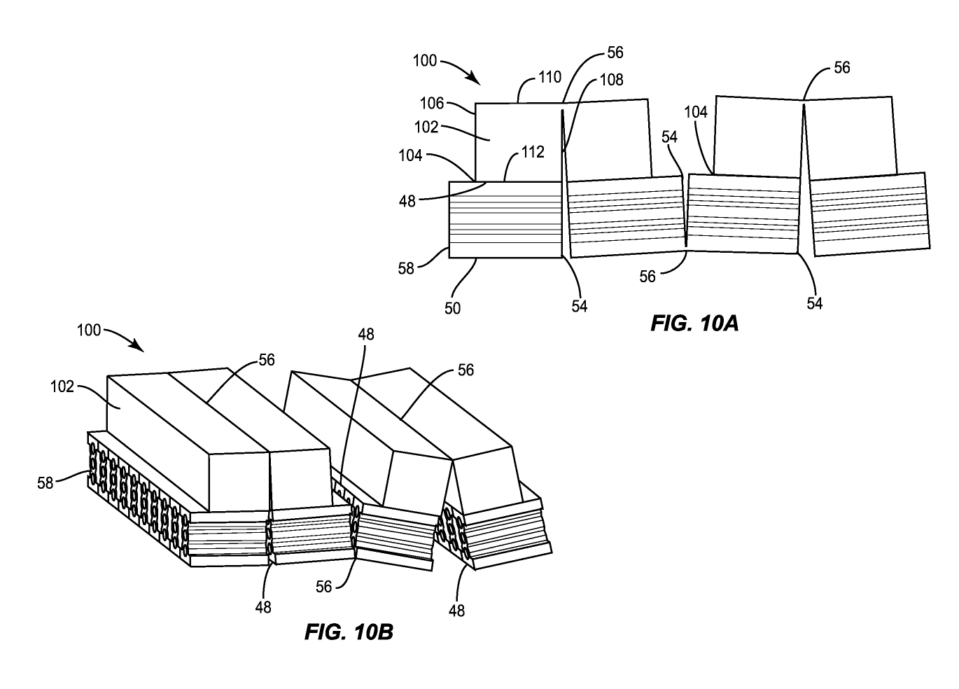

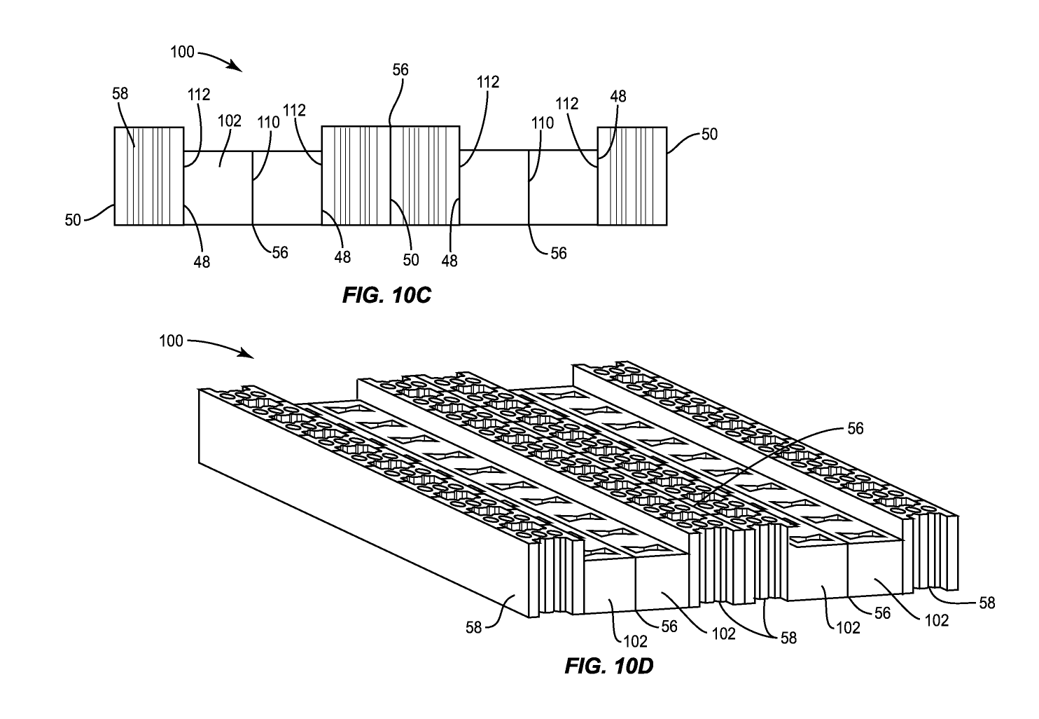

Similar to embodiments described above, it may be desirable to provide a hybrid cushioning structure having different sections of varying height. In this regard, FIGS. 10A through 10D illustrate a cushioning structure 100 having a plurality of elements of a second material connected to the base support members prior to cutting and folding the cushioning structure, according to an alternative embodiment. The alternative cushioning structure 100 of FIGS. 10A through 10D includes individual assemblies 102 of a second material connected to extruded support members 58 at a connection interface 104. In this embodiment, each assembly 102 has end surfaces 106 that are not necessarily coplanar with end surface 52 of extruded support members 58. In this embodiment, cuts 54 create cut end surfaces 108 in in the assemblies 102 that are substantially coplanar with cut end surfaces 52 of extruded support members 58, however. In this manner, when the cushioning structure 100 is rearranged by rotating the individual sections about hinges 56, the resulting cushioning structure 100 has alternating sections of first and second materials having a coplanar lower surface, but with a non-coplanar upper surface, thereby providing a variable height hybrid cushioning profile for the cushioning assembly 100. Similar to the cushioning structure 86 of FIGS. 9A and 9B, each assembly 102 has a top surface 110 and a bottom surface 112, with the bottom surface 112 of the assembly 102 bonded to the top surface 48 of the extruded support sub-members 46 at connection interface 104, by welding or adhesive for example.

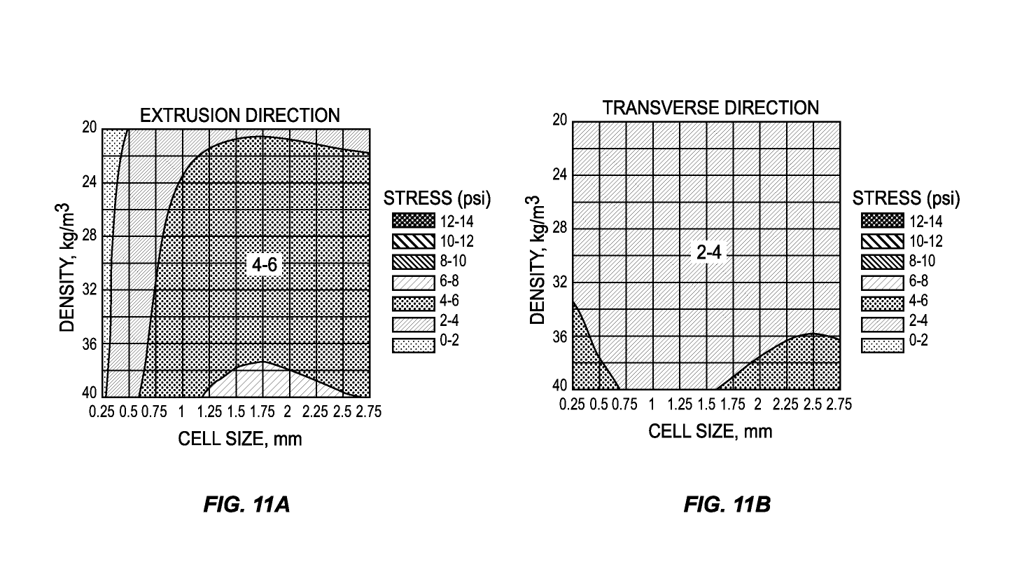

Customization of the support profiles in the above embodiments can also extend to the type and density of foam used in the extruded support sub-members 46 and other components. In this regard, FIGS. 11A and 11B illustrate a comparison of stress profiles at ten percent (10%) compression for an exemplary extruded support member 58 having an extrusion profile according to support sub-members 46 in the extrusion direction and the transverse direction, according to an exemplary embodiment. The stress profiles each comprise a chart of stress across different cell sizes and foam densities. As shown in FIGS. 11A and 11B, stress in the extrusion direction is in the range of 4-6 psi for most combinations of density and cell size, while stress in the transverse direction is in the range of 2-4 psi for a similar range of densities and cell sizes. Based on this comparison, it can be seen that the extrusion direction is more resistant to compression than the transverse direction.

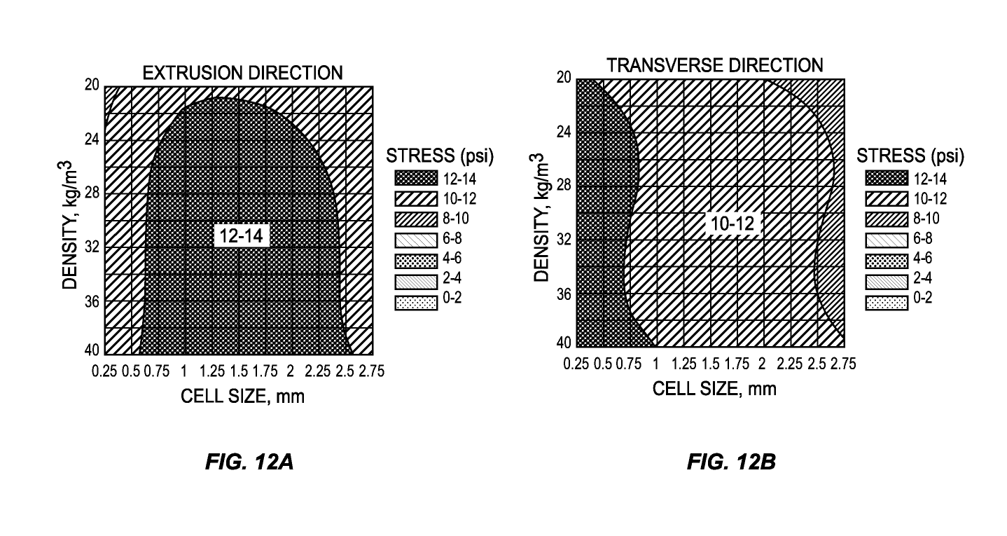

This compression resistance in the extrusion direction is maintained as compression strain increases. In this regard, FIGS. 12A and 12B illustrate a comparison of stress profiles at fifty percent (50%) for an exemplary extruded support member 58 in the extrusion direction and the transverse direction similar to the stress profiles of FIGS. 11A and 11B at a different compression level, according to an exemplary embodiment. At 50% compression, stress in the extrusion direction is 12-14 psi for most cell sizes and densities, while stress in the transverse direction is 10-12 psi for similar cell sizes and densities.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. An extruded foam cushioning structure for a mattress, comprising:
a plurality of extruded support members each having a top surface and a bottom surface that extend in an extrusion direction and two end surfaces that extend in a transverse direction that is transverse to the extrusion direction;
wherein the plurality of extruded support members are connected to each other in a linear array defining a substantially planar lower surface, wherein one end surface of each of the plurality of extruded support members is substantially coplanar with the lower surface.

2. The extruded foam cushioning structure of claim 1, further comprising:
a plurality of hinges connecting each pair of adjacent support members at one of the top surface and the bottom surface of the adjacent support members such that the pair of adjacent support members is able to rotate 180° with respect to each other;
wherein rotating each support members 180° with respect to each of the adjacent support members causes the top surface of each support member to be in contact with the top surface of the adjacent support member, and/or causes the bottom surface of each support member to be in contact with the bottom surface of the adjacent support member; and
wherein rotating each support member 180° with respect to each of the adjacent support members causes one of the end surfaces of each support member to become substantially coplanar with one of the end surfaces of each of the adjacent support member.

3. The extruded foam cushioning structure of claim 1, wherein each extruded support member comprises a first material that includes the top surface, and a second material from the first material that includes the bottom surface.

4. The extruded foam cushioning structure of claim 1, wherein the plurality of extruded support members have unequal lengths in the extrusion direction.

5. The extruded foam cushioning structure of claim 1, wherein the linear array defines a substantially planar upper surface, wherein one end surface of each of the plurality of extruded support members is substantially coplanar with the upper surface.

6. The extruded foam cushioning structure of claim 5, wherein the plurality of extruded support members have equal lengths in the extrusion direction.

7. The extruded foam cushioning structure of claim 1, wherein each extruded support member comprises a plurality of extruded support sub-members connected to each other in a linear array extending in the transverse direction.

8. The extruded foam cushioning structure of claim 7, wherein each of the plurality of extruded support sub-members has a common cross-sectional foam profile including at least one channel extending therethrough in the extrusion direction.

9. The extruded foam cushioning structure of claim 8, wherein the cross-sectional foam profiles of the plurality of extruded support sub-members cooperate with each other such that connecting the extruded sub-members to each other in the linear array defines at least one enclosed channel extending between adjacent extruded support sub-members in the extrusion direction.

10. The extruded foam cushioning structure of claim 7, wherein the plurality of extruded support sub-members are connected to each other via welding.

11. The extruded foam cushioning structure of claim 7, wherein the plurality of extruded support sub-members are connected to each other via an adhesive.

12. The extruded foam cushioning structure of claim 1, wherein each of the plurality of extruded support members is stiffer and more resilient in the extrusion direction than in the transverse direction.

13. A method of forming a foam cushioning structure comprising:
providing an extruded foam structure having a top surface and a bottom surface that extend in an extrusion direction and two end surfaces that extend in a transverse direction that is transverse to the extrusion direction;
cutting the extruded foam structure in the transverse direction at a plurality of locations along the extrusion direction of the extruded foam structure to form a plurality of extruded support members each having a top surface and a bottom surface that extend in the extrusion direction and two end surfaces that extend in the transverse direction;
arranging the plurality of extruded support members such that the extruded support members are connected to each other in a linear array such one of the end surfaces of each of the plurality of extruded support members are coplanar with each other.

14. The method of claim 13, wherein cutting the extruded foam structure in the transverse direction at a plurality of locations defines a plurality of hinges connecting each pair of adjacent support members at one of the top surface and the bottom surface of the adjacent support members such that the pair of adjacent support members is able to rotate 180° with respect to each other; and
wherein the plurality of extruded support members comprises rotating each support members 180° with respect to each of the adjacent support members to cause the top surface of each support member to be in contact with the top surface of an adjacent support member, and/or cause the bottom surface of each support member to be in contact with the bottom surface of an adjacent support member, thereby causing one of the end surfaces of each support member to become substantially coplanar with one of the end surfaces of each adjacent support member.

15. The method of claim 13, wherein each extruded support member comprises a first material that includes the top surface, and a second material from the first material that includes the bottom surface.

16. The method of claim 13, wherein cutting the extruded foam structure causes the plurality of extruded support members to have unequal lengths in the extrusion direction.

17. The method of claim 13, wherein the linear array defines a substantially planar upper surface, wherein one end surface of each of the plurality of extruded support members is substantially coplanar with the upper surface.

18. The method of claim 17, wherein cutting the extruded foam structure causes the plurality of extruded support members to have equal lengths in the extrusion direction.

19. The method of claim 13, wherein providing the extruded foam structure comprises:
extruding a plurality of extruded support sub-members in an extrusion direction, each extruded support sub-member having a top surface and a bottom surface that extend in the extrusion direction and two end surfaces that extend in a direction transverse to the extrusion direction;
connecting the plurality of extruded support sub-members to each other in a linear array extending in the transverse direction to form the extruded foam structure.

20. The method of claim 19, wherein each of the plurality of extruded support sub-members has a common cross-sectional foam profile including at least one channel extending therethrough in the extrusion direction.

21. The method of claim 20, wherein the cross-sectional foam profiles of the plurality of extruded support sub-members cooperate with each other such that connecting the extruded sub-members to each other in the linear array defines at least one enclosed channel extending between adjacent extruded support sub-members in the extrusion direction.

22. The method of claim 19, wherein the plurality of extruded support sub-members are connected to each other via welding.

23. The method of claim 19, wherein the plurality of extruded support sub-members are connected to each other via an adhesive.

24. The method of claim 13, wherein each extruded support member is stiffer and more resilient in the extrusion direction than in the transverse direction.
